(19) United States
(12) Patent Application Publication
(10) Pub. No.: US 2006/0282279 A1
(43) Pub. Date: Dec. 14, 2006

(54) Real estate information system

(76) Inventor: Toshiyuki Waragai, Shizuoka-shi (JP)

Correspondence Address: John S. Egbert;Egbert Law Offices, 7th Floor, 412 Main Street, Houston, TX, 77002, US

(21) Appl. No.: 11/282,035

(22) Filed: Nov. 18, 2005

(30) Foreign Application Priority Data
Jun. 9, 2005 (JP) 2005-168932

(51) Int. Cl. G06Q 99/00

(52) U.S. Cl. 705/1

(57) ABSTRACT

A real estate information system includes a computer system of an information provider memorizing real estate information, and terminals connected to the computer system through the internet. The real estate information includes information on a sick house syndrome concerning each real estate. A user searches through the real estate information by a terminal to select a real estate satisfying the user's desired conditions with respect to the sick house syndrome. The real estate information may further include image information on each real estate.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a real estate information system. More particularly, the invention relates to a real estate information system for providing a person who or whose housemates are suffering from a sick house syndrome, or a sick building syndrome, with information for selecting a real estate free from causing the sick house syndrome or information for taking measures to cope with the sick house syndrome when said person intends to purchase or lease real estate.

The sick house syndrome is a hypersensitivity to chemical substances or allergosis. The sick house syndrome is caused by chemical substances, such as volatile organic compounds, diffused indoors by building materials, interior materials, furniture or daily necessaries.

### BACKGROUND OF THE INVENTION

Japanese Patent Laid-Open Publication No. 2002-15049 discloses a real estate information system, in which real estate information is registered in real estate columns of internet home pages and desired real estate information is searched for therethrough.

In the real estate information system of the prior art, no regard is paid to the sick house syndrome. The real estate information system of the prior art does not provide a person who or whose housemates are suffering from the sick house syndrome with information for selecting a real estate free from causing the sick house syndrome or information for taking measures to cope with the sick house syndrome when said person intends to purchase or lease a real estate.

### BRIEF SUMMARY OF THE INVENTION

It is an object of the invention to obviate the above-mentioned disadvantages of the prior art.

It is another object of the invention to provide a real estate information system which provides a person who or whose housemates are suffering from the sick house syndrome with information for selecting a real estate free from causing the sick house syndrome or information for taking measures to cope with the sick house syndrome when said person intends to purchase or lease a real estate.

These and other objects have been achieved by the following real estate information system.

In the present application, “information provider” means a person who provides a user with real estate information by means of a real estate information system according to the present information.

In the present application, “user” means a person who receives real estate information from the information provider by means of a real estate information system according to the present information.

First, the present invention is a real estate information system comprising:

a computer system of an information provider memorizing real estate information, and terminals connected to said computer system through the internet,

said real estate information including information on a sick house syndrome concerning each real estate, and

a user searching through said real estate information by means of a terminal to select a real estate satisfying the user's desired conditions with respect to the sick house syndrome.

This embodiment has the following advantages.

When a user who or whose housemates are suffering from a sick house syndrome intends to purchase or lease a real estate, the user gives priority to the real estate being free from causing the sick house syndrome over any other conditions of the real estate.

It is very advantageous to such a user that the user can search through information on a sick house syndrome concerning each real estate by means of a terminal to select a real estate satisfying the user's desired conditions with respect to the sick house syndrome.

The user can easily judge whether each real estate is free from causing the sick house syndrome without actually visiting the real estate. It is painful for a person suffering from a sick house syndrome to visit a place which may cause the sick house syndrome.

The information provider can effectively provide the user who or whose housemates are suffering from a sick house syndrome with real estates satisfying the user's desired conditions on the sick house syndrome.

Second, the present invention is a real estate information system comprising:

a computer system of an information provider memorizing real estate information, and terminals connected to said computer system through the internet,

said real estate information including information on a sick house syndrome concerning each real estate and image information on each real estate, and

a user searching through said real estate information by means of a terminal to select a real estate satisfying the user's desired conditions with respect to the sick house syndrome.

In this embodiment, since the real estate information includes image information on each real estate as well as information on a sick house syndrome concerning each real estate, the user who intends to select a real estate can take into consideration not only the information on the sick house syndrome concerning each real estate but also the image information on each real estate.

Third, the present invention is a real estate information system wherein said information on a sick house syndrome concerning each real estate includes information on environments around said each real estate, the age of each building, and building materials including interior materials of each building.

The environments around said each real estate, the age of each building, and building materials including interior materials of each building have a great influence on the sick house syndrome. The user can select a real estate on a basis of the information thereon.

Fourth, the present invention is a real estate information system wherein said computer system further includes a checklist on a sick house syndrome, by means of said checklist said user informing said information provider of the user's condition on the sick house syndrome and materials used in a building in which the user dwells.

In this embodiment, the user can accurately inform the information provider, by means of the checklist, of the user's objective condition on the sick house syndrome and materials used in a building in which the user dwells. The information provider can provide real estates suitable for the user on a basis of the information.

Fifth, the present invention is a real estate information system wherein said information provider makes a judgment on the environmental conditions of said user concerning the sick house syndrome on a basis of said user's condition on the sick house syndrome and said materials used in the building in which the user dwells, said information provider sending information on said environmental conditions through said computer system to the user's terminal.

In this embodiment, the information provider can judge the environmental conditions of the user concerning the sick house syndrome and send information on the environmental conditions of the user through the computer system to the user's terminal. The user can accurately know the environmental conditions.

Sixth, the present invention is a real estate information system wherein said information provider makes improvements on the user's real estate to cope with the sick house syndrome on a basis of said user's condition on the sick house syndrome, said materials used in the building in which the user dwells or environmental conditions of said user, said user selecting, on a basis of said real estate information, a temporary dwelling which satisfies the user's desired conditions concerning the sick house syndrome, said user dwelling in said temporary dwelling until said improvement works are completed.

In this embodiment, the information provider can make improvement works on the user's real estate to cope with the sick house syndrome on a basis of said user's condition on the sick house syndrome obtained by the checklist.

Seventh, the present invention is a real estate information system wherein said computer system is connected to a database of real estate information.

In this embodiment, the information provider can provide the user with real estate information stored in the database.

Eighth, the present invention is a real estate information system comprising:

a computer system of an information provider memorizing real estate information, and terminals connected to said computer system through the internet,

said real estate information including image information on each real estate, and

a user searching through said real estate information by means of a terminal to select a real estate satisfying the user's desired conditions.

In this embodiment, the user can select a real estate satisfying the user's desired conditions on a basis of the image information on each real estate. The user can easily judge whether each real estate satisfies the user's desired conditions without actually visiting the real estate.

The information provider can effectively provide the user with real estates satisfying the user's desired conditions.

### BRIEF DESCRIPTION OF THE SEVERAL VIEWS OF THE DRAWINGS

FIG. 1 is a schematic view of a block diagram showing an example of the real estate information system according to the present invention.

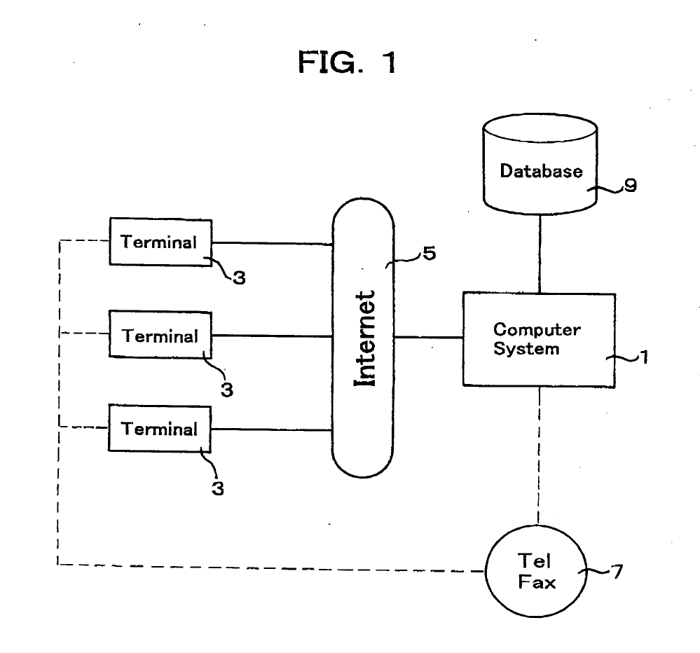

FIG. 2 is a schematic view of a flow chart concerning improvement works made on the user's real estate to cope with the sick house syndrome.

### DETAILED DESCRIPTION OF THE INVENTION

The invention will now be described in detail with reference to the attached drawings.

Reference symbol 1 represents a computer system of an information provider. The computer system 1 memorizes real estate information.

Reference symbol 3 represents a terminal connected to the computer system 1 through the internet 5.

Terminal 3 are used by users. The terminals 3 may be personal computers or cellular telephones. The terminals 3 may not be owned by users.

The real estate information memorized by the computer system 1 is information on real estates and includes information on a sick house syndrome concerning each real estate.

The real estate information memorized by the computer system 1 further includes general real estate information on equipment of buildings, construction of buildings, kitchens, lavatories, bathrooms, stairs, lighting apparatus, hot water supply systems, ranges, air conditioners, plots, parking spaces, elevators, rents, fees for common services, deposits, etc.

The user searches through the real estate information memorized by the computer system 1 by means of the terminal 3 to select a real estate satisfying the user's desired conditions with respect to the sick house syndrome.

The real estate information memorized by the computer system 1 preferably includes not only the information on the sick house syndrome concerning each real estate but also image information on each real estate.

The image information on each real estate includes images of the interior, exterior, environments, and prospects of the real estate.

The information on the sick house syndrome concerning each real estate includes information on environments around each real estate, the age of each building, and building materials including interior materials of each building.

The information on environments around each real estate includes information on the existence of agricultural chemicals such as weed killers in the neighborhood, information on the existence of factories emitting harmful smokes in the neighborhood, information on plants growing in the neighborhood, and information on the population density, air pollution and noises of an area in which the real estate exists.

The information on the age of each building is information as to how old the building is. If the building is old, it is unlikely to cause a sick house syndrome because volatile organic compounds, fungi, molds, etc. have already been emitted.

The information on building materials of each building includes information on materials used in the ceilings, walls, floors and other parts of the building, information as to whether these materials emit harmful volatile organic compounds, etc., and information as to whether fungi, molds, etc. exist in these materials.

The computer system 1 further includes a checklist on a sick house syndrome. By means of the checklist, the user can inform the information provider of the user's condition on the sick house syndrome and materials used in a building in which the user dwells.

An example of the checklist is shown below. The checklist is not limited to the example below. The checklist may be modified in various ways.

Checklist

Please answer to the following questions.

1. Do you have the following symptoms?

Irritated

Shoulders grow stiff.

Eye irritation

Sneezing or sniveling

Allergies such as atopy and pollinosis

Nausea

Pain in the eyes

Languid

Headache

Coughs or asthma

2. When did your symptoms appear?

Long time ago

Within 6 months after moving into the house

Within 1 month after moving into the house

Within 1 year after moving into the house

3. What odors occur to your mind?

Mold

Toluene (paint)

Formaldehyde (adhesive)

Ammonium

Acetaldehyde (cigarettes)

4. What materials occur to your mind?

Wallcovering

Tile

Caulking

Furniture

Adhesive

Flooring

Heat insulating material

Fittings

Paint

Plastered wall

5. What places occur to your mind?

Under the floor

Under the stairs

Entry hall

Closet or boot cupboard

Kitchen

Lavatory

Toilet

Bedroom

Living room

Children's room

Japanese-style room

Ceiling

6. Do you go to hospital regularly?

Yes.

No.

<In case of “Yes”>

What hospital do you go? (You may refuse to answer.)

7. Did your hospital explain the cause and symptom?

Yes.

No.

<In case of “Yes”>

What is the cause?

What is the symptom?

8. What measures are you taking now?

Air cleaner

Deodorant

Charcoal

Wiping

The checklist may contain items asking materials used in the interior finish, furniture, etc. of the user's building.

The information provider makes a judgment on the environmental conditions of the user concerning the sick house syndrome on a basis of said user's condition on the sick house syndrome and the materials used in the building in which the user dwells. The information provider sends information on the environmental conditions through the computer system 1 to the user's terminal 3. The user can accurately know the environmental conditions.

The information provider makes improvement works on the user's real estate to cope with the sick house syndrome on a basis of the user's condition on the sick house syndrome, the materials used in the building in which the user dwells or environmental conditions of the user. The user selects a temporary dwelling which satisfies the user's desired conditions concerning the sick house syndrome on a basis of the real estate information. The user dwells in the temporary dwelling until the improvement works are completed.

The user's real estate on which the improvement works are made may be owned or leased by the user.

The user's real estate on which the improvement works are made includes a real estate which has already undergone some improvement works but need additional works, as well as a real estate which has not undergone any improvement works at all.

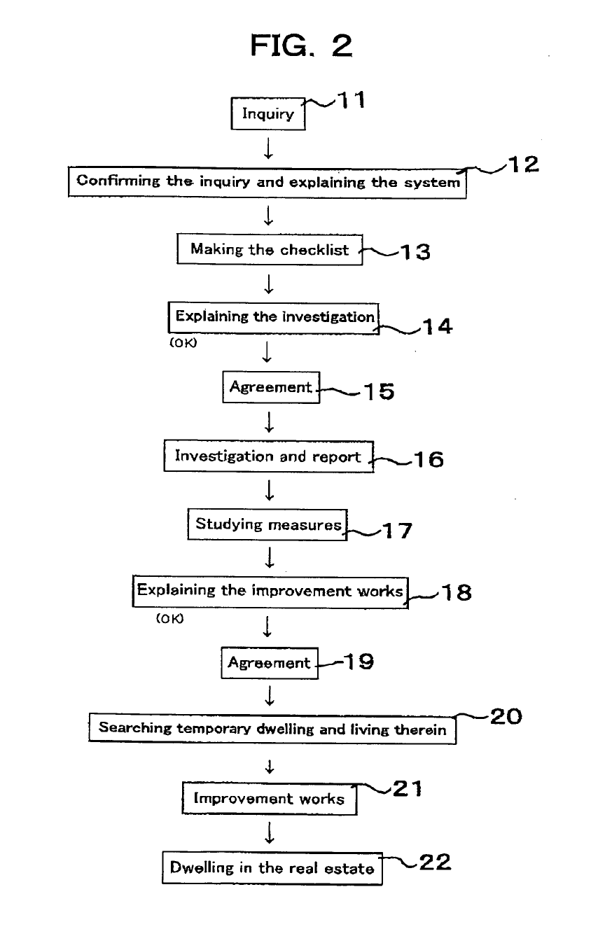

The improvement works to cope with the sick house syndrome are made for example as shown in FIG. 2.

[11] The user inquires of the information provider, by means of the terminal 3, about the improvement works on the user's real estate to cope with the sick house syndrome. The inquiry may be made by telephone or facsimile.

[12] The information provider confirms the inquiry and explains the real estate information system.

[13] The user informs, by means of the checklist, the information provider of the user's condition on the sick house syndrome and materials used in a building in which the user dwells.

[14] The information provider explains to the user a method of investigating the user's real estate and the cost of the investigation.

[15] The user makes an agreement with the information provider with regard to the investigation of the user's real estate.

[16] The information provider investigates the user's real estate, and reports to the user in writing about the results of the investigation.

[17] The information provider studies measures to cope with the sick house syndrome.

[18] The information provider explains to the user a method of the improvement works on the user's real estate to cope with the sick house syndrome and the cost of the works.

[19] The user makes an agreement with the information provider with regard to the improvement works on the user's real estate to cope with the sick house syndrome.

[20] The user searches and selects a suitable temporary dwelling by means of the terminal 3 and lives in the temporary dwelling until the improvement works are completed.

[21] The information provider makes the improvement works on the user's real estate to cope with the sick house syndrome.

[22] After the improvement works are completed, the use dwells in the real estate.

The computer system 1 is connected to a database 9 of real estate information. The database 9 contains real estate information owned by persons other than the information provider.

The real estate information memorized by the computer system 1 may include image information on each real estate in addition to general real estate information on equipment of buildings, construction of buildings, kitchens, lavatories, bathrooms, stairs, lighting apparatus, hot water supply systems, ranges, air conditioners, plots, parking spaces, elevators, rents, fees for common services, deposits, etc.

The computer system 1 may further have typical questions about the sick house syndrome and answers thereto, in addition to said checklist on image information on each real estate.

As many apparently widely different embodiments of the present invention may be made without departing from the spirit and scope thereof, it is to be understood that the invention is not limited to the specific embodiments thereof except as defined in the appended claims.

I claim:

1. A real estate information system comprising:
a computer system of an information provider memorizing real estate information, having terminals connected to said computer system through an internet, wherein said real estate information is comprised of information on a sick house syndrome concerning each real estate, and
a terminal for a user searching through said real estate information to select a real estate satisfying desired conditions of the user with respect to the sick house syndrome.

2. A real estate information system comprising:
a computer system of an information provider memorizing real estate information, having terminals connected to said computer system through an internet, wherein said real estate information is comprised of information on a sick house syndrome concerning each real estate and image information on each real estate, and
a terminal for a user searching through said real estate information to select a real estate satisfying desired conditions of the user with respect to the sick house syndrome.

3. A real estate information system as claimed in claim 1, wherein said information on a sick house syndrome is comprised of information on environments around each real estate, age of each building, and building materials, said building materials being comprised of interior materials of each building.

4. A real estate information system as claimed in claim 1, wherein said computer system is further comprised of a checklist on a sick house syndrome, said checklist by said user informing said information provider of a condition on the sick house syndrome and materials used in a building in which the user dwells.

5. A real estate information system as claimed in claim 4, wherein said information provider makes a judgment on environmental conditions of said user concerning sick house syndrome on a basis of condition on the sick house syndrome by said user and said materials used in the building in which the user dwells, said information provider sending information on said environmental conditions through said computer system to the terminal of the user.

6. A real estate information system as claimed in claim 4, wherein said information provider makes improvement works on real estate of the user to cope with the sick house syndrome on a basis of the condition on the sick house syndrome by said user, said materials used in the building in which the user dwells or environmental conditions of said user, said user selecting, on a basis of said real estate information, a temporary dwelling which satisfies desired conditions of said user concerning the sick house syndrome, said user dwelling in said temporary dwelling until said improvement works are completed.

7. A real estate information system as claimed in claim 1, wherein said computer system is connected to a database of real estate information.

8. A real estate information system comprising:
a computer system of an information provider memorizing real estate information, having terminals connected to said computer system through an internet, wherein said real estate information is comprised of image information on each real estate, and
a terminal for a user searching through said real estate information to select a real estate satisfying desired conditions of said user.
